(19) United States
(12) Patent Application Publication
(10) Pub. No.: US 2023/0121299 A1
(43) Pub. Date: Apr. 20, 2023

(54) SYSTEM AND METHOD FOR DYNAMIC MODEL TRAINING WITH HUMAN IN THE LOOP

(71) Applicant: Edammo, Inc., Iowa City, IA (US)

(72) Inventors: Edward Ratner, Sioux Falls, SD (US); Kallin Carolus Khan, Iowa City, IA (US)

(21) Appl. No.: 17/503,490

(22) Filed: Oct. 18, 2021

(51) Int. Cl. G06N 3/08; G06N 3/04; G06N 20/20; G06K 9/62

(52) U.S. Cl. CPC G06N 3/08; G06N 3/0454; G06N 20/20; G06K 9/623; G06K 9/6256; G06K 9/6263

(57) ABSTRACT

An improved neural network is disclosed that supports rapid retraining using human feedback. A weighted ensemble of Extreme Learning Machines (ELMs) is used to implement a model. The ensemble of ELMs may be trained in parallel with a variation in individual parameters gridding a parameter set selected to achieve consistent accurate model results when the model is trained and subsequently retrained when user feedback data become available. An exemplary application is the scoring of resumes.

### FIELD OF THE INVENTION

The present disclosure generally relates to neural networks used to implement models that learn from responsive to human feedback. More particularly, the present disclosure is related to Extreme Learning Machines with human feedback providing an additional source of training data.

### BACKGROUND

There are numerous tradeoffs between different neural network technologies in terms of training requirement and accuracy. This has limited the ability to use neural networks in certain types of end-use applications in which frequent retraining of the neural network is desirable.

### SUMMARY

Methods, systems, and computer program products are disclosed for using a weighted ensemble of Extreme Learning Machines (ELMs). An ELM parameter space is gridded to vary the parameters of individual ELMs in the ensemble. The ensemble of ELMs may be used to generate a weighted score. An example method includes training, in parallel, an ensemble of Extreme Learning Machines (ELMs) to implement a data analysis model, each ELM in the ensemble of ELMs being assigned a different set of ELM parameters to grid an ELM parameter space. A validation test is performed on each trained ELM in the ensemble of ELMs using a validation data set. A weight is assigned to each ELM in the ensemble of ELMs based on results of the validation test to form a weighted output of the ensemble of ELMs.

An exemplary application of the weighted ensemble of ELMs is to score (classify) media items, with resumes being an example of media items. In some implementations, features are extracted from queries and the ensemble of ELMs is trained based on the extracted features. The scoring may including ranking search results. Voting data by users on the search results may be used as an additional source of training data. An exemplary method includes receiving a user query to search resumes, extracting features from the user query, extracting features from the user query, training an ensemble of Extreme Learning Machines (ELMs) to score the resumes based at least in part on the extracted features and available training data, each ELM being assigned a different set of ELM parameters to grid an ELM parameter space, performing a validation test on each trained ELM using a validation data set, assigning a weight to each ELM based on results of the validation test, scoring the resumes using the weighted output of the ensemble of ELMs, and providing a ranked listing of the resumes to the user.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a block diagram illustrating a general system using an ensemble of ELMs to implement a model in accordance with an implementation.

FIG. 2 is a block diagram illustrating a system using an ensemble of ELMs to implement a model to classify searchable media items in accordance with an implementation.

FIG. 3 is a block diagram illustrating a system using an ensemble of ELMs to score resumes in accordance with an implementation.

FIG. 4 illustrates a server based implementation of a system to use an ensemble of ELMs to implement a model in accordance with an implementation.

FIG. 5 is a flow chart of a high level method of using an ensemble of ELMs in accordance with an implementation.

FIG. 6 is a flow chart of a method of training an ensemble of ELMs in accordance with an implementation.

FIG. 7 is a flow chart of a method forming and using a feature dictionary in accordance with an implementation.

FIG. 8 is a flow chart of a method of using an ensemble of ELMs to score resumes in accordance with an implementation.

FIG. 9 is a flow chart of a method of training an ensemble of ELMs to score resumes in accordance with an implementation.

FIG. 10 is a flow chart of forming a feature and using a feature dictionary to score resumes in accordance with an implementation.

### DETAILED DESCRIPTION

The present disclosure describes systems and methods for using a weighted ensemble of Extreme Learning Machines (ELMs) to achieve rapid training of a model with consistently high accuracy. The individual ELMs in the ensemble may grid a parameter space for the ELMs, with a validation test being used to determine a weight for each trained ELM in the ensemble. Thus, the more accurate ELMs in the ensemble are assigned a higher weight than less accurate ELMs. The gridding of the parameter space may be chosen to achieve a consistently high accuracy of the weighted ensemble of trained ELMs.

The model implemented by the weighted ensemble of trained ELMs could be a classification model, but more generally may be other types of models.

In one implementation, a human in the loop provides feedback on the results of the model. In the case of a classification model, the human user can provide feedback on the accuracy of the scoring performed by the model by voting on search result items. The votes are used to form positive/negative training data. As ELMs can be rapidly trained, the ELM ensemble can be trained in parallel when a search query is initiated, using the same training data. The ELM ensemble can also be retrained based on voting data. In some implementations, a feature dictionary is formed from feature data extracted from search queries. Feature data from a query may be used to train an ELM ensemble.

ELM Background

An individual Extreme Learning Machine (ELM) is a particular type of feedforward neural network that has various advantages and disadvantages compared with other machine learning approaches. A review of ELM technology is provided in the article by Mustafa Abbas Abbod Albadr et al, “Extreme Learning Machine: A Review”, International Journal of Applied Engineering Research, ISSN 0973-4562 Vol. 12, No. 14 (217), pp 4610-4623, the contents of which are hereby incorporated by reference.

Additional background on ELMs on determining weights is found in a paper by G. B. Huang, et al, “Extreme Learning Machine: Theory and Applications,” Neurocomputing, 70(10: 489-501 (2006), the contents of which are hereby incorporated by referenced.

ELMs have many different applications, including classification. See, e.g., G. B. Huang, et al., “Extreme Learning Machine for Regression and Multiclass Classification,” IEEE Transactions on Systems, Man, and Cybernetics-Part B, Cybernetics, 42(2): 513-529 (2012).

ELMs have been used for applications such as regression, classification, sparse coding, and compression features learning. An ELM may be implemented to have a single layer of hidden nodes corresponding to a single layer feedforward network. In ELM, the input layer weights are randomly assigned and the output layer weight may be obtained by using a generalized inverse of the hidden layer output matrix

ELMs typically have a single hidden layer of nodes, although some forms of ELM have more than one hidden layer of nodes. The parameters of hidden nodes (not just the weights connecting inputs to hidden nodes) need not be tuned.

One aspect of ELMs is that in most cases, the output weights of hidden nodes are learned in a single step. ELMs can be trained extremely quickly compared with many other types of neural networks.

There is a vast number of academic papers describing ELMs theory, the applications of ELMs, and variations on ELM. However, while ELMs are fast to train, they are also known to have problems achieving consistently high accuracy. That is, an individual ELM used as a single hidden layer feedforward network may achieve a high accuracy. But accuracy with consistency can be a barrier in many applications.

ELM Ensemble System Examples

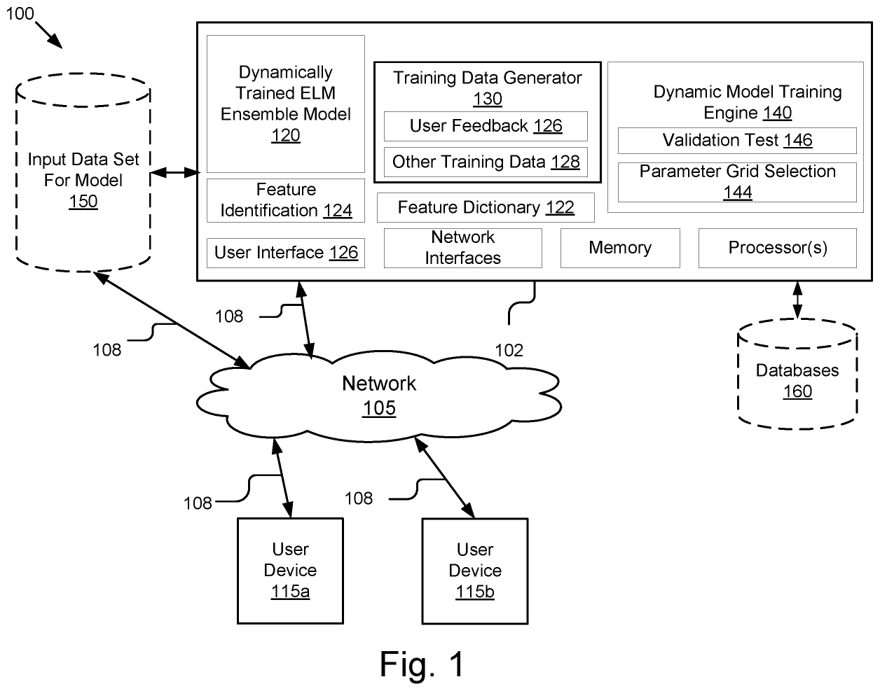

FIG. 1 is a high level diagram of a system 102 to use a trained weighted ensemble of ELMs to implement a model in accordance with an implementation. At a high level, the major components include a trained ELM ensemble model 120, a training data generator 130, and a dynamic model training engine 140. The model operates on an input data set 150 to generate a model output. However, using an ensemble of ELMs permits each individual ELM to have variations in parameters such as a number of neurons, variations in regularization coefficients (e.g., L1 and L2 coefficients), and variations in initialization of random weights in a first layer. This may be implemented during training by a parameter grid selection module 144. The ensemble of ELMs may be used to generate a weighted output model, in which each ELM is weighted based on a result of a validation test 146 such that the more accurate ELMs (as determined by the validate test) are weighted higher. The training data include general training 128 and user feedback 126. The ensemble of ELMs may be trained based on feature data 124 built up in a feature dictionary 122 from feature data provided by a feature identification module 124.

FIG. 1 illustrates a general system that may be implemented on an enterprise network, as a web-based Internet service, or a cloud-based or cloud-supported service. Individual users may use a user device 115 to access a UI to submit problems for the system 102 to solve using the trained ELM ensemble model 120. Individual components may, for example, communicate via a network 105 and individual communication links 108. Individual users may also submit feedback, which in the simplest use case could be votes. Votes may be as simple as yes/no type votes (e.g., positive or negative) although more generally other schemes could be used to acquire user feedback (e.g., providing a user a ratings scale).

The system 102 may be implemented as computer software code with hardware supports such as network interface, memory, processor(s), and databases 160. The system 102 may be implemented in various ways. As some possibilities, it may be implemented as a server based system operating in an enterprise environment, a web-based network service, via a cloud-based, or via a cloud-assisted service.

One application of the system 102 is to perform classification (scoring) of searchable media items, with resumes being an example of media items that are searchable by entering search queries based on criteria such as college degrees, years of work experience, a distance range, etc. The searchable media may be a populated database, such as a set of resumes uploaded to a company's database. Alternatively the searchable media could be, for example, media obtainable from other sources such as public databases, websites, web services, etc.

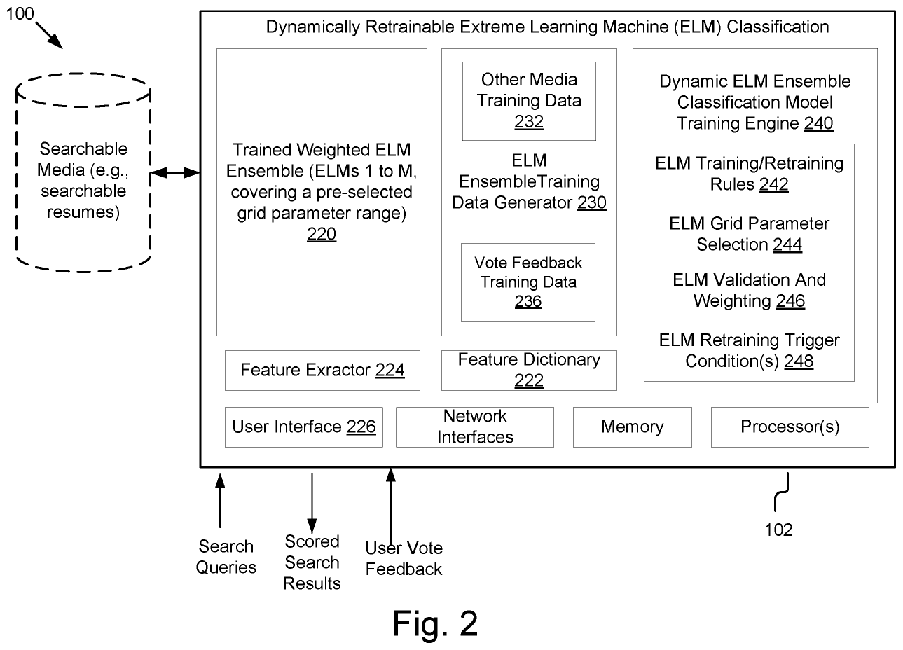

As illustrated in FIG. 2, the system 102 may be implemented to receive user search queries, return scored search results (e.g., in a ranked list), and receive user vote feedback on individual search results. In this example, the trained ELM ensemble 220 outputs a weighted score. Each ELM implements a different set of parameters to grid a parameter space associated with ELM performance/accuracy. A feature extractor 222 extracts features from input search queries. The feature extractor may, for example, extract features from text and ignore irrelevant words. In some implementations, the extracted features are added to a feature dictionary 224 that is used to build up a set of features over many search queries.

The ELM ensemble 220 is trained based on extracted features and the feature dictionary. Vote feedback data 234, if available, may also be used. Other media training data 232 may be used. The training engine 240 includes a grid parameter selection module 244 to grid a parameter space. A validation and weighting module 246 performs a validation test on each trained ELM based on a validation test and weights each trained ELM based on the validation test. General rules for training or retraining the ELM ensemble 242 may be selected, such as rules for using extracted features and features in the feature dictionary during training.

Additionally, specific conditions for triggering training/retraining of the ELM ensemble 248 may be provided. As one example, training of the ELM ensemble may be triggered for each new search query. However, there may be scenarios where a new search query is merely a minor variation of earlier search queries such that retraining would be unlikely to change search results. In some implementations, a user may be provided with options to request reevaluation of their search query after they have provided one or more votes. The retraining may thus be triggered in response to a user command. However, other options are possible, such as automatically performing retraining after a selected number of user votes.

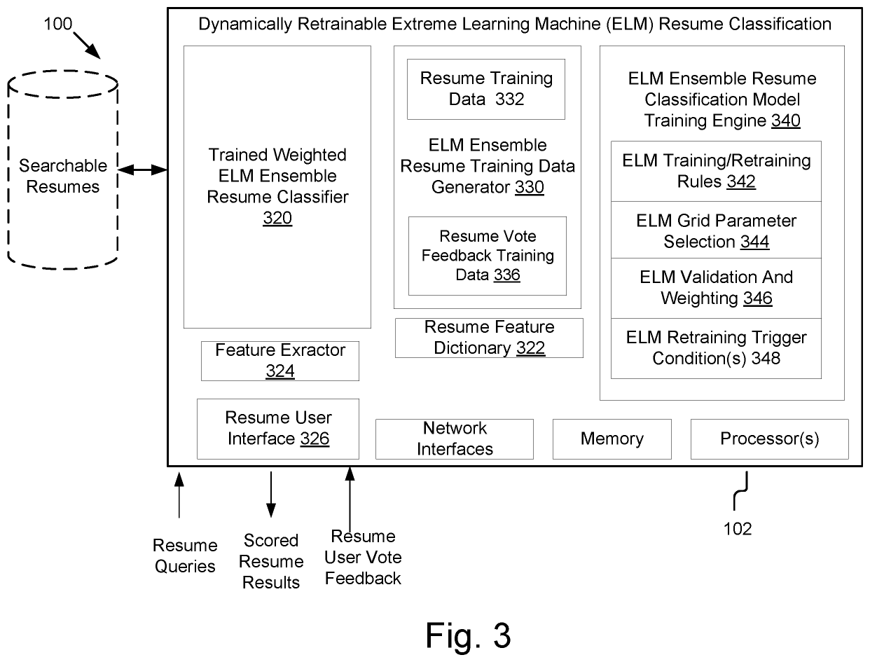

As illustrated in FIG. 3, the system 102 may be specifically implemented to be used for scoring resumes. The training engine 340 includes training/retraining rules 342, grid parameter selection rules 344, validation and weighting 346, and retraining trigger conditions 348. A training data generator 330 includes voter feedback training data 336. A resume feature dictionary 322 is updated with feature data from a feature extractor. The ELM ensemble is trained using a feature set based on extracted features and feature dictionary. The trained weighted ELM resume classifier is trained to score resumes. A resume user interface may be provided to support user submitting resume queries, receiving score resume search results in a ranked order, and permitting user to submit vote feedback on resumes.

However, in an HR application, the searchable media items do not necessarily have to be only text documents or conventional resumes. For example, some professional network websites permit users to upload videos, which may include, for example, people giving talks at technical conferences about their work. In some industries, video resumes are becoming increasingly common as a supplement or even a replacement for conventional resumes. An HR department may, for example, find video information on professional networking sites that may be converted to a text equivalent using natural language processing.

In a general use scenario, individual users utilize a user device 115 to enter search queries for the searchable media items. This results in scoring the searchable media items and may include presenting the scored media items in a ranked order. The score may also optionally be displayed. An individual user who submitted a query may vote on one or more of the search results. The simplest voting system is a positive or negative (thumbs up or thumbs down) vote about an individual media item. However, more generally, a user can vote on as many media items as they wish. Other types of voting systems can also be used, but a thumbs up/thumbs down voting system is easiest to implement.

The votes are used as feedback training data. The retraining of the ELM ensemble model 104 can be in different ways. For example, a user interface may provide a button for a user to request retraining of the model (e.g., a “reevaluate” button). Other conditions could be selected to trigger retraining of the model, such as after a pre-selected number of votes. When the ELM ensemble model is retrained, the training engine 102 uses the votes as an additional source of training data. The features extracted from queries by a feature extractor stored in the feature dictionary may be used to train the ensemble of ELMs. In the training of the ensemble of ELMs, key parameters in a parameter space are gridded, as will be discussed below in more detail. Each trained ELM in the ensemble is tested using a validation data set, with the validation results being used to assign a weight to each ELM in the ensemble.

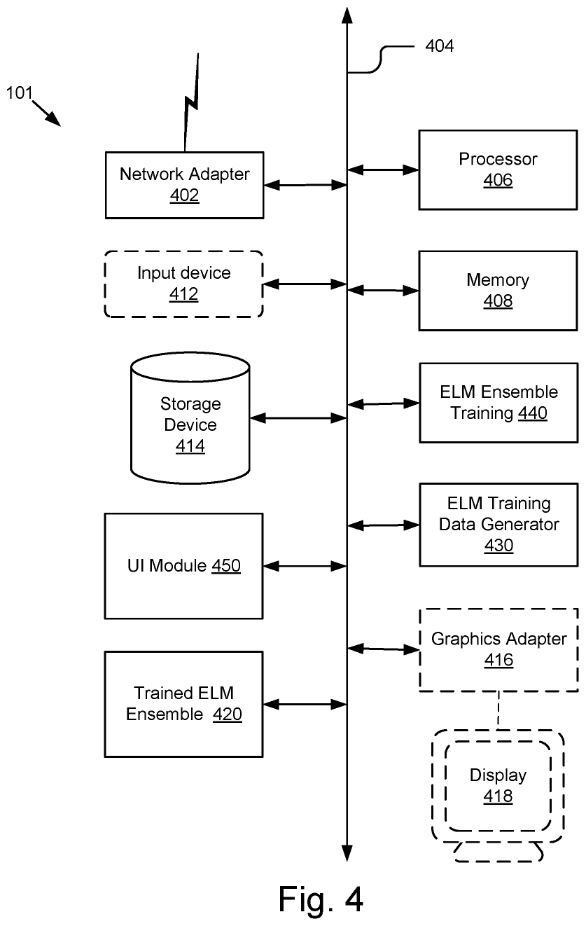

Referring to FIG. 4, while the system may be implemented in different ways, it can be implemented as a server-based system having a data bus 404, processor 406, memory 408, storage device 414, input device 412, network adapter 402, and optional graphics adapter 416 and display 418. Memory units 420, 430, 440, and 450 may store computer program instructions for implementing a UI, using the trained ELM ensemble, training the ELM ensemble, and generating training data.

### Example Methods

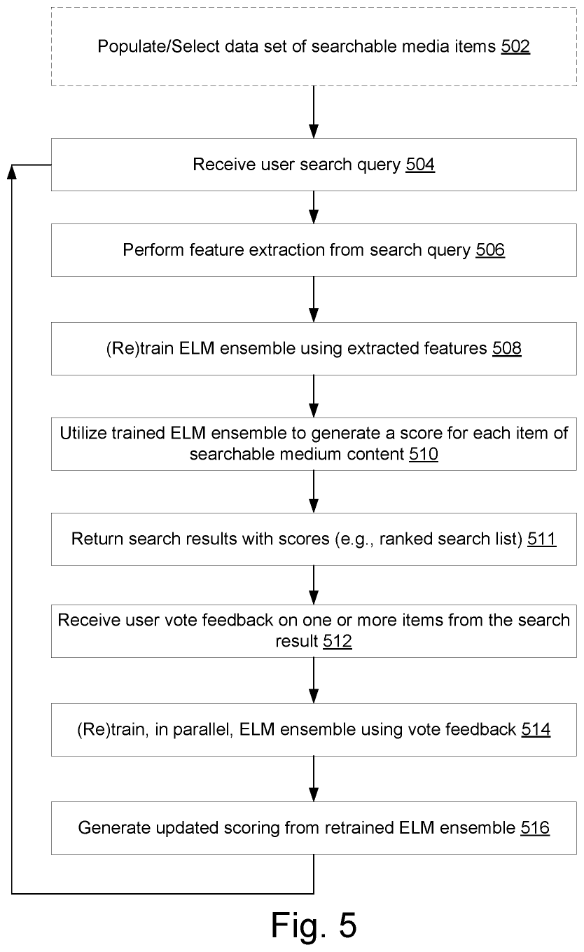

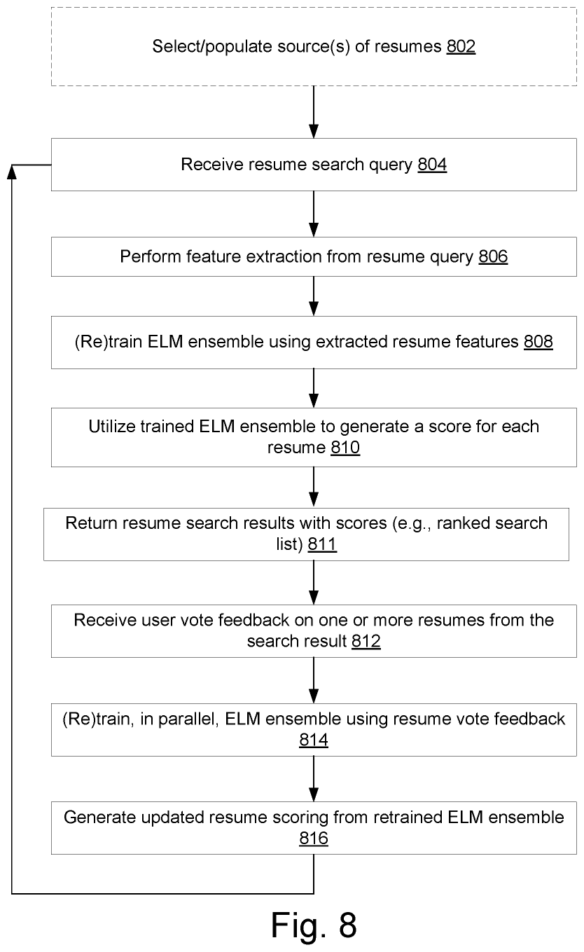

Examples are now provided for two different types of methods. At a high level, general methods related to training and using an ensemble of ELMs for classifying searchable media items are presented in FIGS. 5-7. FIGS. 8-10 are variation specific for training and using an ensemble of ELMs for classifying resumes.

FIG. 5 is a flow chart of a general method for using a trained ELM ensemble to score searchable media items in accordance with an implementation. In block 502 a selection is made of a data set of searchable media items. This may, for example, be a corporate database or a selection of web services that provide access to media items. In block 504, a user search query is received. In block 506, features are extracted from the search query. In block 508, the ELM ensemble is trained using the extracted features. The trained ELM ensemble is used in block 510 to generate a score for each item of searchable media content. The score could be provided to a user in many different ways. For example, as illustrated in block 511, a ranked search result may be returned to the user. Users are provided with the option to vote on individual search results. The system receives user vote feedback for one or more items from the search result in block 512. For example, users could be asked to vote for each media item whether it was useful or whether the user wanted to see more search results like it. For example, a user might vote on the first 10 search results in a ranked list of search results. The simplest voting system is a simple yes/no vote, which corresponds to positive and negative training data.

In block 514, the ELMs in the ensemble are retrained in parallel. Each ELM is trained with the same feature set, the same voting data, etc. In block 516, an updated scoring is performed using retrained ELM ensemble.

The process can optionally be performed over multiple search queries, if desired. For example, in the case of resumes, a recruiter may make minor variations of a search query to find a candidate. Over the course of several search queries for a candidate, the feature dictionary will build up, along with positive and negative votes for individual resumes.

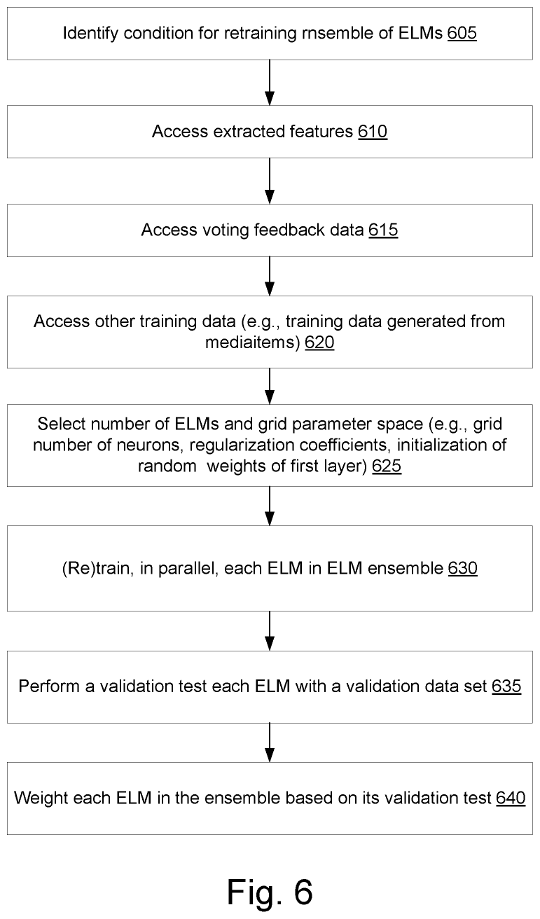

FIG. 6 is a flow chart illustrating a method for training/retraining the ELM ensemble. In block 605, a condition is identified for training/retraining the ensemble of ELMs. For example, the condition might be the receipt of a new search query. As another example, a user may be provided the option to request reevaluation after submitting one or more votes.

In block 610, extracted features are accessed from which the ensemble of ELMs is trained. More generally, the features may come from a feature dictionary built up from features extracted over a series of search queries. If there is voting feedback data, this may be accessed in block 615. Other training data/sample data that is available is accessed in block 620. The ELM ensemble has a variation in ELM parameter that grids a parameter space. This could be implemented in block 625 with a pre-selected number of ELMs in the ensemble along with a pre-selected gridding of the parameter space in terms of factors such as a number of neurons, regularization coefficients, and initialization of random weights in a first layer. The gridding could be “fine” enough to ensure that at least one ELM in the ensemble will provide accurate results. However, more generally, the gridding could be optimized based on empirical studies, recent search result validation test, etc.

In block 630, each ELM in the ensemble is trained in parallel. The data loading can be performed in parallel and the ELM supports fast training.

In block 635, a validation test is performed for each trained ELM in the ensemble using a validation data set. This results, effectively, in a confidence score for each ELM. In block 640, each ELM is weighted based on the results of its validation test results. This results in a weighted score. The use of a weighted score helps to achieve consistent accuracy in model results compared with using a single ELM.

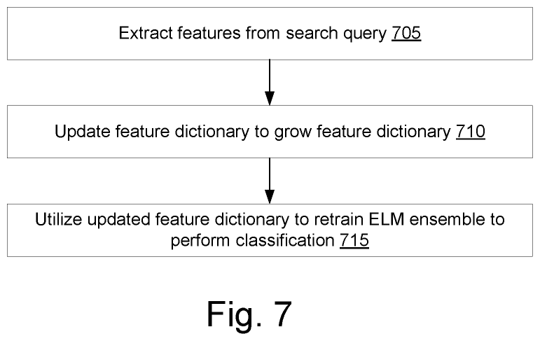

FIG. 7 is a flow chart of a method of using a feature dictionary in accordance with an implementation. In block 705, features are extracted from a current search query. In block 710, the feature dictionary is updated using the extracted features. In block 715, the updated feature dictionary is used to retrain the ELM ensemble to perform classification.

The previous methods may be customized to be specific to the problem of servicing queries for resumes. FIG. 8 is a flowchart that is a variation of FIG. 5, customized for resumes. In block 802 a source of resumes is selected or populated. For example, there are employment-oriented online services in which people post information about themselves about education and employment history that is the equivalent to a resume. There are also online services in which users can upload resumes. In block 804, a resume query is received. For example, an individual resume query may include educational requirements, work experience requirements, etc. In block 806, feature extraction is performed on the resume query. In block 808, the ELM ensemble may be trained based on the extracted resume features. In block 810, the trained ELM ensemble is used to generate a score for each resume. As illustrated in block 811, the scores may be provided by returning a ranked order of the resumes in a search result. In block 812, vote feedback is received from the user for one or more resumes from the search result. This may be, for example, a yes/no vote on a resume. In block 814, the ELM ensemble is retrained in parallel using the resume vote feedback. In block 816, updated resume scoring is generated by the retrained ELM ensemble.

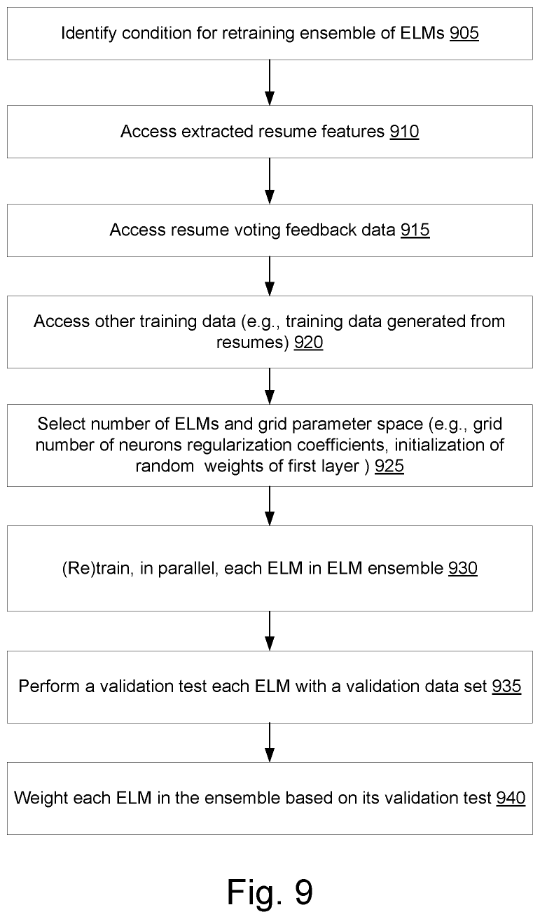

FIG. 9 is a variation of FIG. 6, customized for resumes regarding the training of the ensemble of ELMs to score resumes. In block 905, conditions are identified for training/retraining an ensemble of ELMs. In block 910, extracted resume features are accessed. If voting feedback is available, the voting feedback is accessed in block 915. In block 920, any other available training data/sample data is accessed. In block 925, the number of ELMs and the gridding of the parameter space may be preselected, although more generally it may be optimized over time based on empirical data. In block 930, each ELM in the ELM ensemble is retrained in parallel. In block 935, a validation test is performed on each trained ELM using a validation data set. In block 940, each ELM in the ensemble is weighted based on results of its validation test.

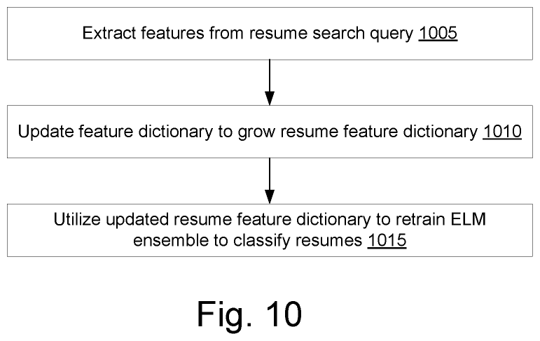

FIG. 10 is a variation of FIG. 7, customized for resumes regarding the building of a feature dictionary and the use of the feature dictionary. In block 1005, features are extracted from a resume search query. In block 1010, the feature dictionary is updated to grow the feature dictionary. In block 1015, the updated feature dictionary is utilized to retrain the ELM ensemble to classify resumes.

One of ordinary skill in the art would understand that the gridding strategy could be optimized for particular problems and for specific aspects of a training set. Using the same gridding strategy of the ELM parameter space for a wide variety of problems is not ideal in practice. In other words, determining an optimum gridding strategy is problem dependent and also depends on aspects of the training set.

The gridding of the ELM parameter space may be customized for a particular problem and for aspects of the training set. For example, if the problem is classifying resumes, then the gridding of the ELM parameter space is chosen based on this problem (classifying resumes) and aspects of the training set used for classifying resumes. In this example, optimizing the gridding strategy can be used, for example, to increase the consistency that the ensemble of ELMs produces generates an accurate classification of resumes based on the training set. However, there may also be other practical considerations on computing and memory resources in order to quickly train/retrain the ensemble of ELMs within time frames that provide an acceptable user experience. Thus the gridding strategy might also, for example also take into consideration keeping the number, M, of ELMs in the ELM ensemble within a reasonable number that need be trained/retrained.

As previously discussed, the ELM ensemble generates a score. In the context of a classification problem, the score (or corresponding probability) is a natural outcome of using an ELM ensemble in which learner votes with its weight. This aspect of the ELM ensemble facilitates using the score in classification problems.

In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware.

Reference in the specification to “one embodiment”, “some embodiments” or “an embodiment” means that a particular feature, structure, or characteristic described in connection with the embodiment is included in at least some embodiments of the disclosed technologies. The appearances of the phrase “in some embodiments” in various places in the specification are not necessarily all referring to the same embodiment.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms, for example, “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer.

The disclosed technologies can take the form of an entirely hardware implementation, an entirely software implementation or an implementation containing both software and hardware elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A method, comprising:
training, in parallel, an ensemble of Extreme Learning Machines (ELMs) to implement a data analysis model, each ELM in the ensemble of ELMs being assigned a different set of ELM parameters to grid an ELM parameter space;
performing a validation test on each trained ELM in the ensemble of ELMs using a validation data set; and
assigning a weight to each ELM in the ensemble of ELMs based on results of the validation test to form a weighted output of the ensemble of ELMs.

2. The method of claim 1, wherein the data analysis model comprises classification.

3. The method of claim 2, wherein the classification comprises scoring media items.

4. The method of claim 3, wherein the classification comprises scoring resumes.

5. The method of claim 1, wherein the parameter space that is gridded includes a number of neurons, regularization coefficients, and initialization of random weights.

6. The method of claim 1, further comprising re-training the ensemble of ELMs using additional training data from user feedback, performing the validation test on each ELM in the ensemble of ELMs, and re-weighting the ensemble of ELMs.

7. The method of claim 3, further comprising re-training the ensemble of ELMs using additional training data from user feedback, performing the validation test on each ELM in the ensemble of ELMs, and re-weighting the ensemble of ELMs.

8. The method of claim 6, where the user feedback comprises voting on scored media items.

9. A computer-implemented method, comprising:
receiving a user query for searchable media items;
extracting features from the user query;
training an ensemble of Extreme Learning Machines (ELMs) to score the searchable media items based at least in part on the extracted features and available training data, each ELM being assigned a different set of ELM parameters to grid an ELM parameter space;
performing a validation test on each trained ELM;
assigning a weight to each ELM based on results of the validation test;
scoring the searchable media items using the weighted output of the ensemble of ELMs; and
returning search results to the user query based on the scoring of the searchable media items.

10. The computer-implemented method of claim 9, further comprising receiving user feedback on the scoring, using the user feedback as an additional form of training data, re-training the ensemble of ELMs, performing the validation test on the retrained ensemble of ELMs, re-weighting the ensemble of trained ELMs based on the validation test.

11. The computer-implemented method of claim 10, further comprising re-scoring the searchable media items using the re-weighted and re-trained ensemble of trained ELMs.

12. The computer-implemented method of claim 9, wherein the parameter space that is gridded includes a number of neurons, regularization coefficients, and initialization of random weights.

13. The computer-implemented method of claim 10, wherein user feedback comprises positive votes and negative votes.

14. The computer-implemented method of claim 9, wherein the method further comprises generating a feature dictionary from extracted features and using the feature dictionary in at least one subsequent search query to train the ensemble of ELMs.

15. The computer-implemented method of claim 9, wherein the searchable media items comprise resumes, and the ensembles of ELMs is trained to score resumes.

16. A computer-implemented method, comprising:
receiving a user query to search resumes;
extracting features from the user query;
training an ensemble of Extreme Learning Machines (ELMs) to score the resumes based at least in part on the extracted features and available training data, each ELM being assigned a different set of ELM parameters to grid an ELM parameter space;
performing a validation test on each trained ELM using a validation data set;
assigning a weight to each ELM based on results of the validation test;
scoring the resumes using the weighted output of the ensemble of ELMs; and
providing a ranked listing of the resumes to the user.

17. The computer-implemented method of claim 16, further comprising receiving user feedback on the scoring of the resumes, using the user feedback as an additional form of training data, re-training the ensemble of ELMs, performing the validation test on the retrained ensemble of ELMs, re-weighting the ensemble of trained ELMs based on the validation test, re-scoring the resumes using the re-weighted and re-trained ensemble of trained ELMs, and providing a re-ranked listing of the resumes to the user.

18. The computer-implemented method of claim 16, wherein the parameter space that is gridded includes a number of neurons, regularization coefficients, and initialization of random weights.

19. The computer-implemented method of claim 17, wherein user feedback comprises positive votes and negative votes.

20. The computer-implemented method of claim 16, wherein the method further comprises generating a feature dictionary from extracted features and using the feature dictionary in at least one subsequent search query to train the ensemble of ELMs.

21. A non-transitory computer readable medium having instructions which when executed on a processor implement a method to generate a trained machine learning model, comprising:
training, in parallel, an ensemble of Extreme Learning Machines (ELMs) to implement a data analysis model, each ELM in the ensemble of ELMs being assigned a different set of ELM parameters to grid an ELM parameter space;
performing a validation test on each trained ELM in the ensemble of ELMs using a validation data set; and
assigning a weight to each ELM in the ensemble of ELMs based on results of the validation test to form a weighted output of the ensemble of ELMs.
